(19) United States
(12) Patent Application Publication
(10) Pub. No.: US 2008/0065805 A1
(43) Pub. Date: Mar. 13, 2008

(54) PCI-Express multimode expansion card and communication device having the same

(75) Inventors: Kun-Fang Wu, Taipei City (TW); Fong-Ming Kuo, Yonghe City (TW); Yi-Jen Lin, Sijhih City (TW)

Correspondence Address: TROXELL LAW OFFICE PLLC, SUITE 1404, 5205 LEESBURG PIKE, FALLS CHURCH, VA, 22041, US

(73) Assignee: Cameo Communications, Inc.

(21) Appl. No.: 11/518,417

(22) Filed: Sep. 11, 2006

(51) Int. Cl. G06F 13/00; G06F 3/00

(52) U.S. Cl. 710/301; 710/2

(57) ABSTRACT

The present invention discloses a PCI-Express multimode expansion card comprising a PCI-Express interface port for insertion into a PCI-Express slot of a motherboard, a PCI-Express expansion port, a USB expansion port, and a jumper circuit connecting the PCI-Express interface port and the two expansion ports. The PCI-Express expansion port provides expandability by allowing the attachment of a PCI-Express interfaced peripheral device, and the USB expansion port provides expandability by allowing the attachment of a USB-interfaced peripheral device. As such, a single PCI-Express multimode expansion card inserted into a PCI-Express slot configured on the motherboard can be used to attach two peripheral devices with different interface, thereby achieving the function of multimode expansion.

### BACKGROUND OF INVENTION

1. Field of the Invention

The present invention relates to a PCI-Express multimode expansion card and communication device having the same, more particularly a PCI-Express multimode expansion card and communication device having the same that can be inserted into the PCI-Express slot of a motherboard and allow a PCI-Express interfaced peripheral device and a USB-interfaced peripheral device to be attached to the PCI-Express slot.

2. Description of the Prior Art

Personal computers used to use peripheral component interface (PCI), such as VGA (video graphics array) display card, sound card, network card, data card, video capture card, TV card, SCSI card, and 1394 adaptor card as the transmission interface to connect to devices of different functions. Because PCI peripheral devices share the use of PCI bandwidth, the more peripheral devices are connected to the computer, the less bandwidth is allocated to each device, thereby slowing down the transmission speed of the device.

Nowadays with the computing speed of personal computers and the amount of data transmitted by the peripheral devices increase dramatically, computers need faster bandwidth to deal with the transmission load. The inadequate bandwidth of PCI becomes a bottleneck in the internal data transmission of computer. Thus Intel embarked on the development of a new-generation of PCI-Express transmission interface, which offers faster bandwidth to allow peripheral devices to transmit data between them more rapidly and efficiently. For example, the 3D graphics processing in games requires faster central processor as well as faster bandwidth to transmit the computing results to the display card. Other peripheral devices, such as gigabyte Ethernet, ultra wideband (UWB) wireless network, high definition content-related hardware, and RAID controller, all require greater bandwidth and consistent connection performance. Only PCI-Express transmission interface specification can meet the demands.

Currently in personal computers, the motherboard is typically disposed with one or two PCI-Express slots in consideration of manufacturing costs and the space available inside the computer, hence limiting the number of external PCI-Express interfaced peripheral devices that may be connected to the computer.

### SUMMARY OF INVENTION

The primary object of the present invention is to provide a PCI-Express multimode expansion card insertable into a PCI-Express lot of a motherboard and providing multimode expansion function by allowing the attachment of a PCI-Express interfaced peripheral device and an USB-interfaced peripheral device to the PCI-Express slot.

Another object of the present invention is to provide a communication device having a PCI-Express multimode expansion card. The communication device is an ultra wideband (UWB) wireless networking device, which can be connected to a PCI-Express slot of a motherboard via the PCI-Express multimode expansion card.

To achieve the aforesaid objects, the PCI-Express multimode expansion card in one embodiment of the invention comprises a PCI-Express interface port, a first expansion port, a second expansion port, and a jumper circuit. The PCI-Express interface port is configured on one side of the PCI-Express multimode expansion card and consists of at least: a plurality of USB-interface pins and a plurality of PCI-Express interface pins. The first expansion port is an interface port compliant with PCI-Express specification, and the second expansion port is an interface port compliant with USB specification. The jumper circuit is connected between the PCI-Express interface port and the first expansion port, and between the PCI-Express interface port and the second expansion port. The first expansion port is connected at least to the PCI-Express interface pins via the jumper circuit, and the second expansion port is connected at least to the USB interface pins via the jumper circuit. As such, a first peripheral device that supports PCI-Express interface can be attached to the first expansion port, and a second peripheral device that supports USB interface can be attached to the second expansion port.

In a preferred embodiment, either the first expansion port or the second expansion port is attached with an ultra wideband (UWB) wireless networking device. The UWB wireless networking device further consists of: a connector interface port insertable into one of the expansion ports of the PCI-Express multimode expansion card for transmission of data signals of communication protocol supported by said expansion port, an antenna for sending/receiving UWB wireless signals, a UWB front-end unit coupled to the antenna, a UWB controller coupled to the UWB front-end unit for signal modulation, and a signal conversion module connected between the UWB controller and the connector interface port to perform conversion of signals between the expansion port-supported communication protocol and the UWB communication protocol. Such design achieves the effect of indirectly connecting the UWB wireless networking device to the PCI-Express slot of the motherboard. At the same time, the other expansion port of the PCI-Express multimode expansion card can be used to connect other peripheral devices (including but not limited to a wireless local area network (WLAN) device).

### BRIEF DESCRIPTION OF THE DRAWINGS

The details of the present invention will be more readily understood from a detailed description of the preferred embodiments taken in conjunction with the following figures.

FIG. 1 is a structural diagram showing connection between the PCI-Express multimode expansion card of the invention and a terminal on motherboard.

FIG. 2 is the circuit diagram of the PCI-Express multimode expansion card and a block diagram showing its connection to an external device.

FIG. 3 is a diagram showing the standard function definitions of the PCI-Express pins on the PCI-Express multimode expansion card of the invention.

FIG. 4 is a diagram showing the PCI-Express multimode expansion card of the invention connecting simultaneously to two wireless transceivers (i.e. peripheral devices) with different communication interface.

### DETAILED DESCRIPTION

The main technical feature of the PCI-Express multimode expansion card of the invention is to make use of the pins on the connector interface specified by the PCI-Express protocol for transmission of PCI-Express signals and the additional USB2.0 connecting pins already built-in. Thus via a jumper circuit, the PCI-Express multimode expansion card of the invention is configured with an expansion port compatible with the PCI-Express pins, and another expansion port extended from the USB2.0 pins on the PCI-Express interface. As such, the PCI-Express multimode expansion card of the invention allows the attachment of two peripheral devices (one using PCI-Express communication protocol and the other using USB2.0 communication protocol) to a single PCI-Express slot on the motherboard to achieve the function of multimode expansion.

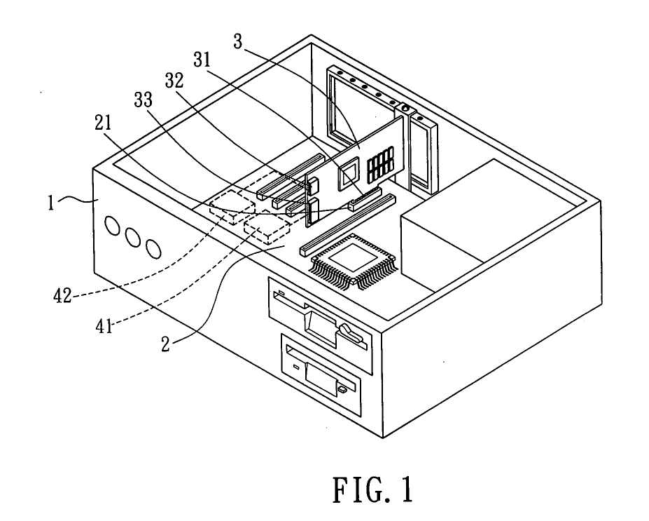

FIGS. 1, 2 and 3 are respectively a structural diagram showing the connection between the PCI-Express multimode expansion card of the invention and a terminal on motherboard, the circuit diagram of the PCI-Express multimode expansion card and a block diagram showing its connection to an external device, and a diagram showing the standard function definitions of the PCI-Express pins on the PCI-Express multimode expansion card of the invention.

As shown in FIG. 1, the PCI-Express multimode expansion card 3 is inserted into the PCI-Express slot 21 on the motherboard 2 of computer 1, and PCI-Express multimode expansion card 3 and motherboard 2 are connected and communicate with each other through slot pins and communication protocol compliant with PCI-Express specification. The computer 1 can be a desktop computer as shown in FIG. 1, or a laptop computer, a mini-barebone system, or a server system. The computer 1 can be disposed with other components and devices in addition to the aforementioned motherboard 2 and PCI-Express lot 21, including but not limited to central processor, a plurality of PCI slots, DRAM, hard drive, and power supply. Those components are prior art and not a technical feature of the invention, and therefore will not be elaborated here.

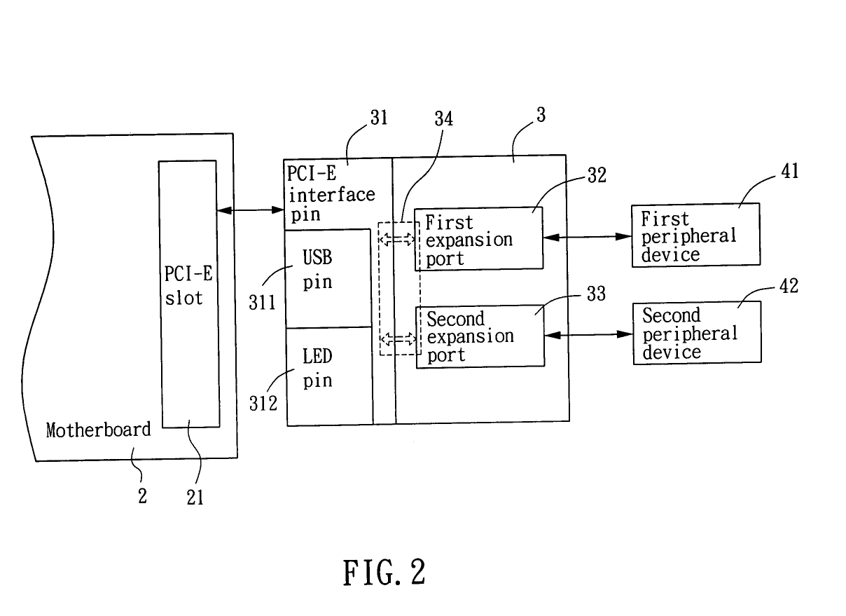

Referring to FIG. 1 and FIG. 2, the PCI-Express multimode expansion card 3 further comprises: a PCI-Express interface port 31, a first expansion port 32, a second expansion port 33, and a jumper circuit 34. The PCI-Express interface port 31 has a so-called gold finger structure which consists of a plurality of metal pins. In addition, the size and configuration of PCI-Express interface port 31 are compatible with the PCI-Express slot pins, so the PCI-Express multimode expansion card can be directly inserted into the PCI-Express slot 21 of motherboard 2 and become electrically connected to the motherboard 2.

In the preferred embodiment of the PCI-Express multimode expansion card 3 as shown in FIG. 1 and FIG. 2, the PCI-Express interface port 31 is disposed on one side of the PCI-Express multimode expansion card 3 for insertion into the PCI-Express slot 21 of motherboard 2. The first expansion port 32 and the second expansion port 33 are arranged in the vicinity of the other side of PCI-Express multimode expansion card 3 for the attachment of a first peripheral device 41 and a second peripheral device 42. A jumper circuit 34 is used to connect the PCI-Express interface port 31 with the two expansion ports 32, 33.

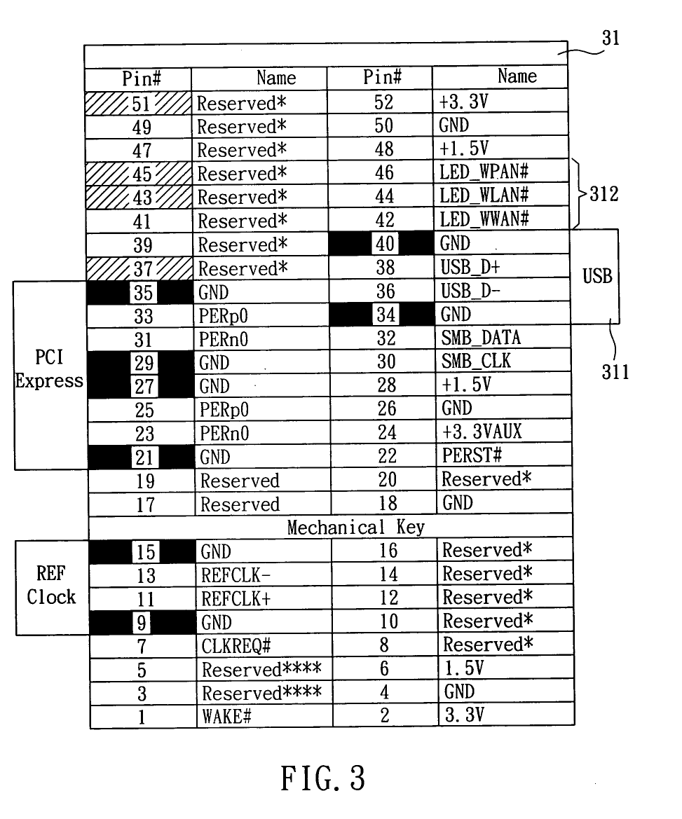

As shown in FIG. 3, the PCI-Express interface port 31 of the PCI-Express multimode expansion card 3 conforms to the standard PCI-Express specification and has 52 pins, of which, pins No. 21, 23, 25, 27, 29, 31, 33 and 35 are pins used for transmitting PCI-Express signal; pins No. 9, 11, 13, and 15 are pins for transmitting reference clock signal; pins 34, 36, 38 and 40 are built-in USB2.0 interface pins 311 supported by standard PCI-Express specification; pins No. 42, 44 and 46 are three sets of LED pins 312. The LED pins 312 are connected to a plurality of LED indicators (not shown in the figure) configured on the PCI-Express multimode expansion card 3 to relay the status of the card to user through the display of LED indicator.

In this embodiment as shown in FIGS. 1, 2 and 3, the first expansion port 32 is an interface slot complaint with mini PCI-Express specification. The pins of the first expansion port 32 are connected to the pins on PCI-Express interface port 31 for transmitting PCI-Express signals via the jumper circuit 34 (i.e. pins #21, 23, 25, 27, 29, 31, 33, and 35 shown in FIG. 3). In another embodiment, the first expansion port 32 is a standard 52-pin PCI-Express slot. In such event, all 52 pins of the PCI-Express interface port 31 are connected to the first expansion port 32 via the jumper circuit 34. As such, the first peripheral device 41 attached to the first expansion port 32 can communicate with the motherboard 2 via the PCI-Express interface and communication protocol.

The second expansion port 33 is a USB2.0 interface port. The pins of second expansion port 33 are connected to the pins on PCI-Express interface port 31 used to transmit USB2.0 signals via the jumper circuit 34 (i.e. pins #34, 36, 38, and 40 shown in FIG. 3). As such, the second peripheral device 42 attached to the second expansion port 32 can communicate with the motherboard 2 via the USB2.0 interface and communication protocol.

Because the PCI-Express multimode expansion card 3 only needs a jumper circuit 34 to connect the PCI-Express interface port 31 to the two expansion ports 32, 33 without using additionally a driver IC or signal conversion circuit for the conversion of signals or communication protocols, the circuit complexity and design cost of PCI-Express multimode expansion card 3 are both low. In addition, it allows two peripheral devices 41, 42 with different interface specification to be attached to the PCI-Express slot 21 of motherboard 2 to achieve the function of multimode expansion.

In this embodiment, the first peripheral device 41 is a device compliant with PCI-Express or mini PCI-Express specification, including but not limited to: PCI-E display card, RAID expansion card, WLAN, UWB wireless networking device, or gigabyte Ethernet. The second peripheral device 42 is a USB or USB2.0 compliant peripheral device, including but not limited to USB hub, USB WLAN, bluetooth USB transmitter, USB UWB wireless networking device, USB Ethernet LAN, or USB input device.

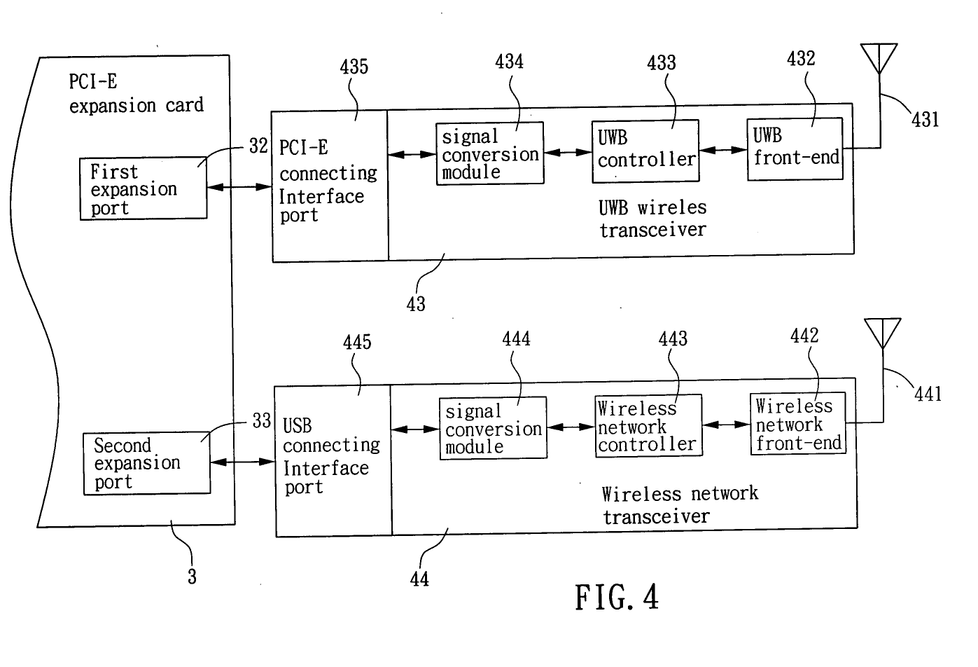

FIG. 4 is a diagram showing the PCI-Express multimode expansion card 3 of the invention connecting simultaneously to two wireless transceivers 43, 44 (i.e. peripheral devices) with different communication protocols. Wireless transceiver 43 is a UWB wireless transceiver 43 that supports PCI-Express interface specification and further comprises: an antenna 431, a UWB front-end unit 432, a UWB controller 433, a signal conversion module 434, and a PCI-Express connector interface port 435.

The antenna 431 is for enhancing the receiving/sending of UWB signals. The UWB front-end unit 432 is electrically connected to antenna 431 to reduce the signal noise or enhance the signals received/sent by antenna 431 to facilitate the transmission of signals. The UWB controller 433 is coupled to the UWB front-end unit 432 to modulate the data signal to be sent into UWB wireless signals or modulate the UWB signals received into data signals. The signal conversion module 434 is coupled to the UWB controller 433 to convert data signals between UWB communication protocol and PCI-Express communication protocol. The PCI-Express connector interface port 435 is coupled to the signal conversion module 434, compliant with PCI-Express interface specification and insertable into the first expansion port 32 of PCI-Express multimode expansion card 3 for the transmission of data signals compliant with PCI-Express communication protocol.

The other wireless transceiver 44 is a WLAN wireless transceiver 44 that supports USB interface specification and further comprises: an antenna 441, a wireless network front-end unit 442, a wireless network controller 443, a signal conversion module 444, and a USB connector interface port 445.

The antenna 441 is for enhancing the receiving/sending of wireless signals. The wireless network front-end unit 442 is electrically connected to antenna 441 to reduce the signal noise or enhance the signals received/sent. The wireless network controller 443 is coupled to the wireless network front-end unit 442 to modulate the data signal to be sent into WLAN wireless signals or modulate the WLAN signals received into data signals. The signal conversion module 444 is coupled to the wireless network controller 443 to convert data signals between USB communication protocol and WLAN communication protocol. The USB connector interface port 445 is coupled to the signal conversion module 444, compliant with USB2.0 interface specification and insertable into the second expansion port 33 of PCI-Express multimode expansion card 3 for the transmission of data signals compliant with USB or USB2.0 communication protocol.

In the embodiment shown in FIG. 4, the PCI-Express multimode expansion card 3 of the invention can connect to a UWB wireless transceiver 43 and a WLAN wireless transceiver 44 simultaneously, where the UWB wireless transceiver 43 communicates and transmits signals with the motherboard of the connected computer (not shown in the figure) using PCI-Express communication protocol, and the WLAN wireless transceiver 44 transmits data signals using USB communication protocol. Such design allows the computer to support simultaneously two wireless transceivers 43, 44 with different communication modes, while using only one PCI-Express slot, which completely addresses the drawback of prior arts.

Yet in another embodiment, it is easy to come up with the idea of changing the design of the aforementioned UWB wireless transceiver 43 into a USB2.0 interfaced device that is attached to the second expansion port 33, while changing the design of the aforementioned WLAN wireless transceiver 44 into a PCI-Express interfaced device that is attached to the first expansion port 32. Or the PCI-Express multimode expansion card 3 has only one expansion port attached with a wireless transceiver, while the other expansion port is attached with other peripheral devices instead of a wireless transceiver. In other words, the embodiments cited above should not be construed as limitation to the scope of application. Technical spirits and modifications defined based on the claims of the invention fall under the protected scope of the invention. That is, all modifications and alterations without departing from the spirits of the invention and appended claims shall be construed as further embodiments of the invention.

While the invention has been described by way of examples and in terms of the preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures. Accordingly, that above disclosure should be construed as limited only by the metes and bounds of the appended claims.

What is claimed is:

1. A PCI-Express multimode expansion card, comprising:
a PCI-Express interface port configured on one side of the PCI-Express multimode expansion card and having a plurality of pins, the plurality of pins further consisting of a plurality of USB interface pins and a plurality of PCI-Express interface pins;
a first expansion port which is an interface port compliant with PCI-Express specification;
a second expansion port which is an interface port compliant with USB specification; and
a jumper circuit connecting the PCI-Express interface port to the first expansion port, and connecting the PEI-Express interface port to the second expansion port; wherein the first expansion port is connected at least to the PCI-Express interface pins via the jumper circuit, and the second expansion port is connected at least to the USB interface pins via the jumper circuit.

2. The PCI-Express multimode expansion card according to claim 1, wherein said first expansion port provides expandability by allowing the attachment of a PCI-Express interfaced first peripheral device, and said second expansion port provides expandability by allowing the attachment of a USB-interfaced second peripheral device.

3. The PCI-Express multimode expansion card according to claim 1, wherein the plurality of pins of the PCI-Express interface port further contain a plurality of LED pins to control the display of LED indicator.

4. The PCI-Express multimode expansion card according to claim 1, wherein said PCI-Express interface port has 52 pins, and said fist expansion port is connected at least to pins #21, 23, 25, 27, 29, 31, 33 and 35 of the PCI-Express interface port via the jumper circuit, while said second expansion port is connected at least to pins #34, 36, 38 and 40 of the PCI-Express interface port via the jumper circuit.

5. The PCI-Express multimode expansion card according to claim 1, wherein said PCI-Express multimode expansion card is not disposed with any signal conversion circuit but with said jumper circuit only.

6. The PCI-Express multimode expansion card according to claim 1, wherein said PCI-Express interface port is insertable into a PCI-Express slot of a motherboard.

7. A communication device having a PCI-Express multimode expansion card, comprising:
a PCI-Express multimode expansion card, further comprising:
a PCI-Express interface port configured on one side of the PCI-Express multimode expansion card and insertable into a PCI-Express slot of an external motherboard;
a first expansion port;
a second expansion port; and
a jumper circuit connecting the PCI-Express interface port to the first expansion port, and connecting the PCI-Express interface port to the second expansion port; and
a peripheral device capable of external communication, which attaches to either the first expansion port or the second expansion port and engages in signal transmission with the motherboard via the PCI-Express interface port.

8. The communication device according to claim 7, wherein said first expansion port provides expandability by allowing the attachment of a PCI-Express interfaced first peripheral device, and said second expansion port provides expandability by allowing the attachment of a USB-interfaced second peripheral device.

9. The communication device according to claim 7, wherein said PCI-Express interface port has 52 pins, and said first expansion port is connected at least to pins #21, 23, 25, 27, 29, 31, 33 and 35 of the PCI-Express interface port via the jumper circuit, while said second expansion port is connected at least to pins #34, 36, 38 and 40 of the PCI-Express interface port via the jumper circuit.

10. The communication device according to claim 7, wherein said PCI-Express multimode expansion card is not disposed with any signal conversion circuit but with said jumper circuit only.

11. The communication device according to claim 7, wherein said peripheral device is one of the following: wireless local area network (WLAN) device, bluetooth transmitter, and ultra wideband (UWB) wireless networking device.

12. The communication device according to claim 7, wherein said peripheral device supports either PCI-Express interface or USB interface.

13. The communication device according to claim 7, wherein said peripheral device is a wireless transceiver and further comprises:
a connector interface port insertable into one of the expansion ports on PCI-Express multimode expansion card for transmission of data signal compliant with the expansion port-supported communication protocol;
an antenna used for receiving/sending wireless signals;
a front-end unit coupled to the antenna;
a controller coupled to the front-end unit for signal modulation; and
a signal conversion module connected between the controller and the connector interface port that carries out the task of signal conversion between the expansion port-supported communication protocol and the communication protocol of the wireless transceiver.

14. A communication device, comprising:
a PCI-Express multimode expansion card, further consisting of: a PCI-Express interface port insertable into a PCI-Express slot of an external motherboard, at least one expansion port, and a jumper circuit connecting the PCI-Express interface port and the at least one expansion port; and
an ultra wideband (UWB) wireless networking device, further consisting of: a connector interface port insertable into one of the expansion ports of PCI-Express multimode expansion card for transmission of data signals compliant with the expansion port-supported communication protocol, an antenna used for receiving/sending UWB wireless signals, a UWB front-end unit coupled to the antenna, a UWB controller coupled to the UWB front-end unit for signal modulation, and a signal conversion module connected between the UWB controller and the connector interface port to carry out the task of signal conversion between the expansion port-supported communication protocol and the UWB communication protocol.

15. The communication device according to claim 14, wherein said at least one expansion port consists of a first expansion port and a second expansion port; said PCI-Express interface port further consists of a plurality of USB interface pins and a plurality of PCI-Express interface pins; wherein the first expansion port is connected at least to the PCI-Express interface pins via the jumper circuit, and the second expansion port is connected at least to the USB interface pins via the jumper circuit.

16. The communication device according to claim 15, wherein said first expansion port provides expandability by allowing the attachment of a PCI-Express interfaced first peripheral device, and said second expansion port provides expandability by allowing the attachment of a USB-interfaced second peripheral device.

17. The communication device according to claim 15, wherein the plurality of pins of the PCI-Express interface port further contain a plurality of LED pins to control the display of LED indicator.

18. The communication device according to claim 15, wherein said PCI-Express interface port has 52 pins, and said first expansion port is connected at least to pins #21, 23, 25, 27, 29, 31, 33 and 35 of the PCI-Express interface port via the jumper circuit, while said second expansion port is connected at least to pins #34, 36, 38 and 40 of the PCI-Express interface port via the jumper circuit.

19. The communication device according to claim 15, wherein said PCI-Express multimode expansion card is not disposed with any signal conversion circuit but with said jumper circuit only.

20. The communication device according to claim 15, wherein the connector interface port of said UWB wireless networking device is compliant with PCI-Express interface specification and connected to the first expansion port.
